(19) United States
(12) Patent Application Publication
(10) Pub. No.: US 2025/0215841 A1
(43) Pub. Date: Jul. 3, 2025

(54) Whispering gallery mode fusion power plant and rocket propulsion

(71) Applicant: Janos Dobos, Pécs (HU)

(72) Inventor: Janos Dobos, Pécs (HU)

(21) Appl. No.: 18/397,126

(22) Filed: Dec. 27, 2023

(51) Int. Cl. F02K 9/97; G21B 1/05

(52) U.S. Cl. CPC F02K 9/97; G21B 1/05

(57) ABSTRACT

The invention is a whisper gallery mode pulsed magneto-inertial fusion solution, that enables the construction of small-size, typically 2 mm diameter, magnetless fusion reactors, fusion power plants and fusion rocket engines. The invention uses magnetic fields excited by whispering gallery mode radiation and secondary radiations excited by whispering gallery mode radiation to control the flow of fusion fuel, plasma compression, focusing of fast ignition wakefield radiation, synchronized formation of fusion fuel droplets, formation of magnetic valves, and formation of magnetic nozzles. The invention can be used in two ways: if the burning and expanding fusion fuel is sent into outer space, it generates thrust for rockets, if it is sent to a heat exchanger, then electricity is produced by interposing a steam turbine in power plants.

### FIELD OF THE INVENTION

The invention relates to fusion power plants, fusion rockets driven by whispering gallery mode radiation.

### BACKGROUND

Generation of electrical power, both for space and terrestrial applications, is becoming increasingly important. Accordingly, there is a need in the arts to provide a more efficient and effective propulsion system for space vehicles and for electrical power generation for both space and terrestrial applications.

Whispering gallery mode is a possible way towards small-size, cheap and efficient fusion reactors: The whispering gallery mode works on the principle of ray reflection and describes wave motion moving around a concave surface. The reflected waves can be subatomic particle radiation (e.g. alpha, electron, neutron radiation) or electromagnetic radiation (e.g. laser, gamma, X-ray radiation) that interact with the concave reflecting surface and explode symmetrically inward toward the center, producing secondary radiation and kT strength magnetic fields.

The current state of the art in relation to the fast particle igniton used in the invention: The concept of rapid ignition of inertial fusion targets is to separate fuel compression from fuel ignition, so the plasma is first compressed and then the hot spot of the compressed plasma is ignited with an external, injected beam, typically a focused proton beam. One option for fast ignition is to fire a short-pulse laser at a thin foil mounted inside a conical structure to generate a proton pulse. Protons are accelerated from the back surface of the foil and due to the curved shape of the foil and the focusing effect of the cone, they enter the compresse plasma. The biggest challenge of using this solution is the fact that the trajectory of protons is easily deflected due to collisions and self-generated electromagnetic fields within the plasma, which significantly impairs the connection between the proton and the hot spot of the plasma, and the efficiency of energy deposition. Therefore, more reliable focusing of the proton beams is necessary.

The current state of the art in relation to the wakefield accelerators used in the invention: In wakefield acceleration, particles such as protons are accelerated in a bubble created by electrons via a plasma wave. The process is generated by ultrashort laser pulses, high-energy shock waves or energetic particle beams adjusted to the parameters of the plasma. These techniques offer the possibility of making high-performance particle accelerators that are much smaller than traditional devices and thus quickly ignite the plasma. In this case too, reliable focusing of the proton beams is required. According to research, electrons with higher energy can be obtained with wakefield acceleration in a magnetized plasma than in a non-magnetized plasma. In their study entitled “Extremely brilliant GeV y-rays from a two-stage laser-plasma accelerator”, Xing Long Zhu and his colleagues showed that high-energy gamma rays can be generated in two stages with wakefield acceleration. In the first acceleration stage, a plasma wake is driven by a multi-PW laser pulse propagating in an underdense plasma channel, where efficient electron injection and acceleration result in a multi-GeV, low-emittance, high-charge, and high-density electron beam. The laser pulse then enters a higher-density plasma region that acts as a radiator, where collimated bright y-rays are produced by the dense high-energy electrons in the enhanced electrostatic fields of the bubble in the denser plasma. In this case too, the focusing of the beams must be improved.

Fusion power plants: Current fusion power plant developments are primarily focused on fusion power plants that magnetically control the fusion plasma, such as the ITER and JET tokamak power plants or the linear plasma collision power plants of Helion Energy Inc. and TAE Technologies. Another direction of research is on inertial or magnetically inertial confinement fusion power plants, see the capsule solutions of the US Livermore National Ignition Facility, or Focused Energy Inc, or First Life Fusion Inc, or the liquid metal power plants of Zap Energy Inc or General Fusion Inc. The solutions are large and therefore expensive, further size reduction is necessary.

Rocket engines: Currently, humanity does not have a high-speed, high-thrust, low-fuel rocket engine that responds quickly in time and provides adequate planetary protection against asteroids and comets. For this reason, it is necessary to search for new fusion rocket engine solutions.

Laser-controlled magnetic field: According to the current state of science, quasi-static magnetic fields of up to 800 Tesla can be created during the interaction of laser pulses with a strength of 500 J and a capacitor coil target, the hot electrons act as a voltage source. The efficiency of the solution can be improved with whispering gallery mode.

In U.S. Pat. No. 9,524,802B2, Apparatus and methods for fusion based power generation and engine thrust generation, John Thomas Slough describes a solution in which the FRC magnetically confined plasma; collapses a metal shell about the FRC plasma; and establishes a fusion reaction in response to collapsing the metal shell about the FRC plasma. The efficiency of the construction can be improved with whisper mode radiation.

The path leading to the present invention was paved by the inventor's previous inventions entitled “U.S. Ser. No. 18/299,151, “Whispering gallery mode fusion reactor” and “U.S. Ser. No. 18/240,362 “Whispering gallery mode fusion reactor with fast ignition”.

### SUMMARY

The invention is a whispering gallery mode pulsed magneto inertial fusion solution. “Pulse” means that the fusion reaction occurs in discrete pulses rather than continuously, while “magneto-inertial” means that the fusion conditions are created by the whispering gallery mode radiation generated magnetic field and secondary radiation generated by the whispering gallery mode radiation. Under fusion conditions, we mean that the plasma is heated to a temperature of more tan 150 million degrees Celsius by whispering gallery mode radiation, compressed to a density of approximately 500-1000 grams/cm3 (i.e. 10\hat{ }20-10\hat{ }26 particle/cm3), and these conditions are maintained for approximately 10-1000 ns. The invention uses magnetic fields excited by whispering gallery mode radiation and secondary radiations excited by whispering gallery mode radiation to control the flow of fusion fuel, plasma compression, focusing of fast ignition wakefield radiation, synchronized formation of fusion fuel droplets, formation of magnetic valves, and formation of magnetic nozzles. The invention can be used in two ways: if the burning and expanding fusion fuel is sent into outer space, it generates thrust for rockets, if it is sent to a heat exchanger, then electricity is produced by interposing a steam turbine in power plants. The solution makes it possible to extract the electric current directly through a coil system, in which the change in the magnetic field of the plasma creates an electric current.

The invention is best understood with reference to the drawings.

### BRIEF DESCRIPTION OF THE DRAWINGS

FIG. 1. the principle of whispering gallery mode fusion power plant and rocket propulsion.

FIG. 2. shows the working principle of the focused wakefield fast ignition radiation.

FIG. 3. shows the generation process of fusion fuel droplets.

FIG. 4. presents the principle of generating liquid metal droplets filled with fusion fuel.

FIG. 5. presents the operating principle of solenoid valves.

FIG. 6. presents the operating principle of magnetic nozzles.

FIG. 7. shows the embodiment of the whispering gallery mode fusion power plant and rocket drive operating with fusion fuel droplets.

FIG. 8. shows the embodiment of the whispering gallery mode fusion power plant and rocket drive operating with liquid metal droplets filled with fusion fuel.

### DETAILED DESCRIPTION

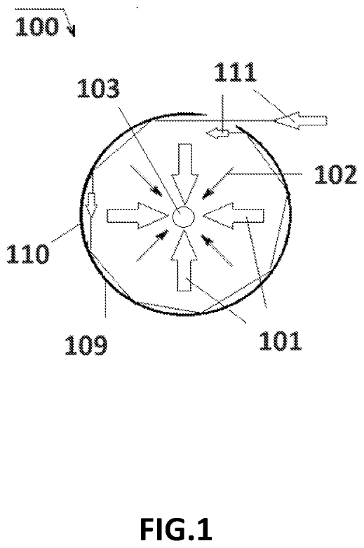

FIG. 1. illustrates the principle of 100 whispering gallery mode fusion power plants and rocket propulsion, 101 magnetic fields generated by whispering gallery mode radiation, 102 secondary radiations generated by whispering gallery mode radiation, 103 compressed fusion fuel generated by 101 magnetic fields generated by whispering gallery mode radiation and 102 secondary radiations generated by whispering gallery mode radiation. Part of the 111 laser radiation falling on the 110 concave surface of the 109 reactor space used by the invention is reflected from the 110 concave surface and begins to move in a circular motion, while another part generates electrons at the point of impact as a result of the collision. The drift of hot electrons towards cooler points induces an ultra-high-strength electric current, which, according to the laws of physics, creates magnetic fields excited by ultra-high-strength 101 magnetic fields generated by whispering gallery mode radiation, i.e. a pressure that compresses the 103 compressed fusion fuel to fusion conditions. In addition to the above, the 111 laser radiation also generates hot electrons that leave the 110 concave surface and enter the cavity surrounded by the 110 concave surface and, exploding inwards, generate 102 secondary radiations generated by the whispering gallery mode radiation, i.e. create pressure for the symmetrical compression of the 103 compressed fusion fuel. During the experiments, in the small 109 reactor space, the largest diameter of which was 2 mm, the 111 laser radiation with an energy of 500 J generated a 101 magnetic field generated by the whispering gallery mode radiation with a strength of 100 Tesla and 102 secondary radiations generated by the whispering gallery mode radiation. The compressive force of these together compressed 103 compressed fusion fuels to a density of 600 g/cm3-1000 g/cm3 and a temperature of 150-250 million degrees Celsius.

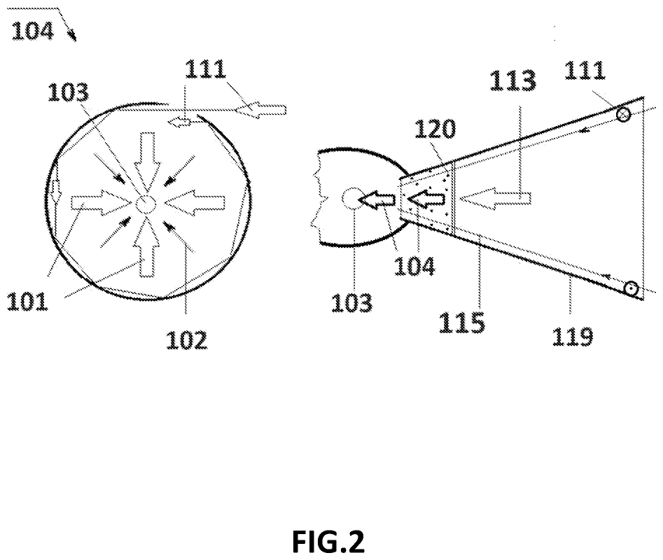

FIG. 2. shows the working principle of focused 104 wakefield fast ignition radiation which generated by 101 magnetic fields generated by whispering gallery mode radiation and 102 secondary radiations geneated by whispering gallery mode radiation. In the case of the solution according to the invention, additional energy was introduced into the 103 compressed fusion fuel through 104 wakefield fast ignition radiation. The 104 wakefield fast ignation radiation was focused by 111 laser radiation i.e the 101 magnetic fields generated by whispering gallery mode radiation and 102 secondary radiations geneated by whispering gallery mode radiation. Therefore, for fast ignition 115 conical magnetic fields generated by whispering gallery mode radiation were used to focus focused 104 wakefield fast ignition radiations. As previously written, the wakefield acceleration is created in two steps by the 113 fast ignition laser. It first generates multi-GeV electron bubbles with ptotons in the 120 magnetized low-density plasma in the 119 cone, and then enters and ignites the denser 103 compressed fusion fuel.

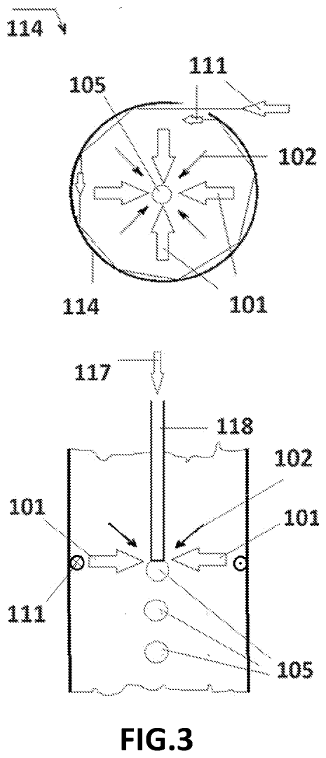

FIG. 3 shows the generation process of 105 fusion fuel droplets generated by 101 magnetic fields generated by whispering gallery mode radiation and 102 secondary radiations generated by whispering gallery mode radiation. In the 114 droplet generator according to the invention, the 105 fusion fuel droplets are generated by the 101 magnetic fields generated by the whispering gallery mode radiation and the 102 secondary radiations generated by the whispering gallery mode radiation that exist for 10 ns after the 111 laser radiations. In the initial state, the 111 laser radiations do not provide energy, the 117 fusion fuel is not affected by the deforming force of the 101 magnetic fields generated by the whispering gallery mode radiation and the 102 secondary radiations generated by the whispering gallery mode radiation, therefore the 117 fusion fuel can flow unhindered to the end of the 118 capillary tube. When the 111 laser radiation is shot, the 101 magnetic fields generated by the whispering gallery mode radiation and the 102 secondary radiations generated by the whispering gallery mode radiation generate a circular pressure force that causes a section of the 117 fusion fuel to deform, stretch, and exerts pressure on the underlying to the 117 fusion fuel column, causing the 105 fusion fuel droplets to be generated. The size and speed of the 105 fusion fuel droplets depends on the flow rate of the 117 fusion fuel and the pressure prevailing in the 118 capillary tube. The 101 magnetic field generated by whispering gallery mode radiation and the 102 secondary radiations generated by the whispering gallery mode radiation synchronized for a time-cycle of 10 ns periodically and evenly break off the 105 fusion fuel droplets.

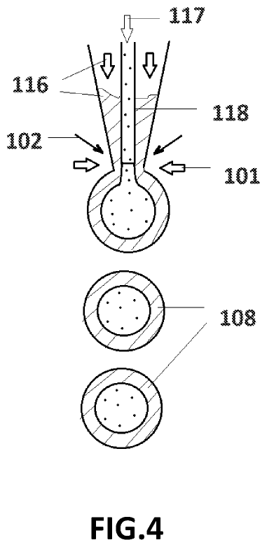

FIG. 4. presents the principle of generation of 108 liquid metal droplets filled with 117 fusion fuel which generated by 101 magnetic fields generated by whispering gallery mode radiation and 102 secondary radiations generated by whispering gallery mode radiation, which is the same as what was written before, the difference is that we blow the 117 fusion fuel into the 116 liquid metal flowing in front of the 118 capillary tube that carries the 117 fusion fuel, and form a drop-bubble

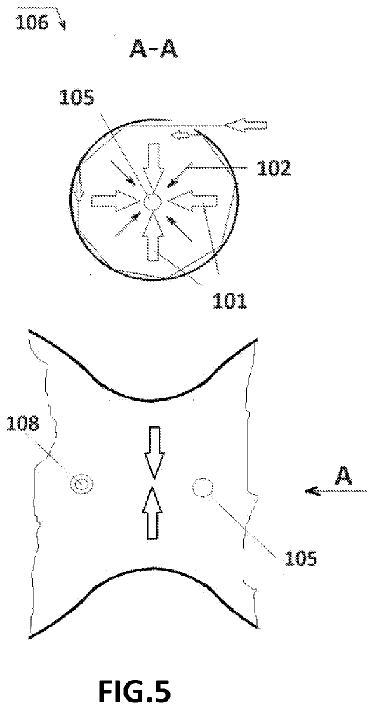

FIG. 5. shows the operating principle of 106 magnetic valves. The 101 magnetic fields generated by the whispering gallery mode radiation and the 102 secondary radiations generated by the whispering gallery mode radiation create a narrowing pressure force that prevents the further progress of the the 105 fusion fuel droplets, and the 108 liquid metal droplets filled with fusion fuel.

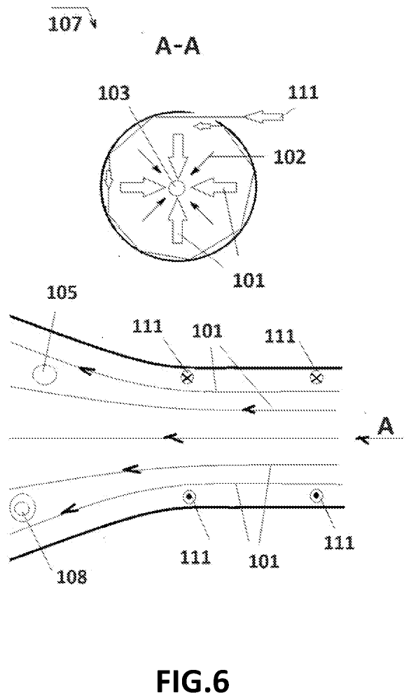

FIG. 6. shows the operating principle of the 107 magnetic nozzles. The 101 magnetic fields generated by whispering gallery mode radiation and 102 secondary radiations generated by whispering gallery mode radiation created by 111 laser radiation fired into at least two places create an expanding, accelerating pressure force that accelerates the further movement of 105 fusion fuel droplets and 108 liquid metal droplets filled with fusion fuel.

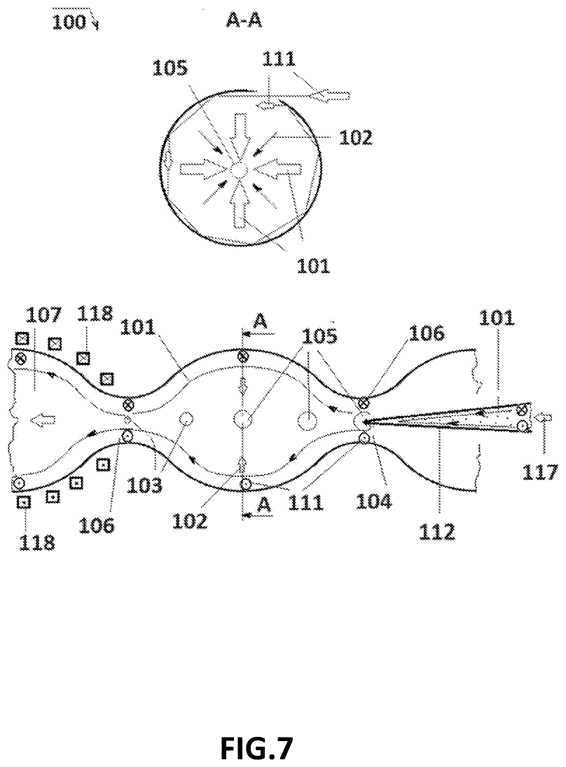

FIG. 7 shows an embodiment of 105 fusion fuel droplet powered 100 whispering gallery mode fusion power plants and rocket propulsion, which comprising: 101 magnetic fields generated by whispering gallery mode radiation, 102 secondary radiation generated by whispering gallery mode radiation, and that generated by them the 103 compressed fusion fuel, the 104 wakefield fast ignition radiation, the 105 fusion fuel droplets, the 106 magnetic valves, the 107 magnetic nozzles, the 117 fusion fuel, and the 112 capillary tubes. The 105 fusion fuel droplets are levitated and compressed due to the compressive force of the 101 magnetic fields generated by the whispering gallery mode radiation and the 102 secondary radiations generated by the whispering gallery mode radiation, while reaches 500-1000 grams/cm3 (i.e. 10\hat{ }20-10\hat{ }26 particle number per cm3) density, then along with 104 wakefield fast ignition radiation, they enter the 107 magnetic nozzle, and then fly out from there at the end of the fusion process. The residence time of the 105 fusion fuel droplets can be adjusted by the direction of the pressure force of the 101 magnetic fields generated by the whispering gallery mode radiation and the 102 secondary radiations generated by the whispering gallery mode radiation compactness and flow rate. The solution makes it possible to extract the electric current directly through a 118 coil system, in which the change in the magnetic field of the plasma creates an electric current.

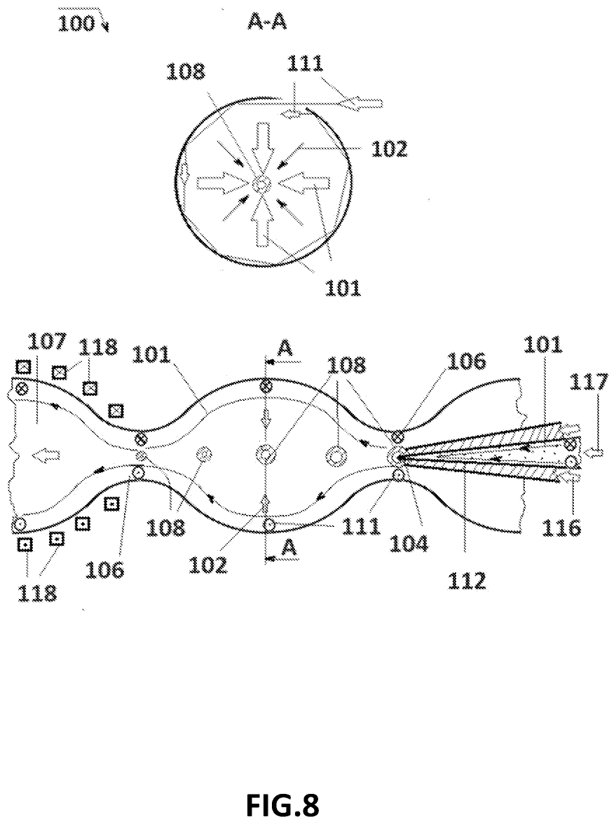

FIG. 8 shows an embodiment of 108 liquid metal droplets filled with fusion fuel powered 100 whispering gallery mode fusion power plants and rocket propulsion, which comprising: 101 magnetic fields generated by whispering gallery mode radiation, 102 secondary radiation generated by whispering gallery mode radiation, and that generated by them the 103 compressed fusion fuel, the 104 wakefield fast ignition radiation, the 108 liquid metal droplets filled with fusion fuel, the 106 magnetic valves, the 107 magnetic nozzles, the 117 fusion fuel, and the 112 capillary tubes. The 108 liquid metal droplets filled with fusion fuel filled are levitated and compressed due to the compressive force of the 101 magnetic fields generated by the whispering gallery mode radiation and the 102 secondary radiations generated by the whispering gallery mode radiation, while reaches 500-1000 grams/cm3 (i.e. 10\hat{ }20-10\hat{ }26 particle number per cm3) density, then along with 104 wakefield fast ignition radiation, they enter the 107 magnetic nozzle, and then fly out from there at the end of the fusion process. The residence time of the 108 liquid metal droplets filled with fusion fuel can be adjusted by the direction of the pressure force of the 101 magnetic fields generated by the whispering gallery mode radiation and the 102 secondary radiations generated by the whispering gallery mode radiation compactness and flow rate. The solution makes it possible to extract the electric current directly through a 118 coil system, in which the change in the magnetic field of the plasma creates an electric current.

It should be emphasized that the above-described embodiments of the 100 whispering gallery mode fusion power plant and rocket propulsion are merely possible examples of implementations of the invention. Many variations and modifications may be made to the above-described embodiments. All such modifications and variations are intended to be included herein within the scope of this disclosure and protected by the following claims.

1. Whispering gallery mode fusion power plant and rocket propulsion (100) characterized by comprising:
magnetic fields generated by whispering gallery mode radiation (101),
secondary radiations generated by whispering gallery mode radiation (102),
compressed fusion fuel (103) generated by magnetic fields generated by whispering gallery mode radiation (101) and secondary radiations generated by whispering gallery mode radiation (102),
wakefield fast ignition radiation (104) focused by magnetic fields generated by whispering gallery mode radiation (101) and secondary radiations generated by whispering gallery mode radiation (102),
fusion fuel droplets (105) generated by magnetic fields generated by whispering gallery mode radiation (101) and secondary radiations generated by whispering gallery mode radiation (102),
magnetic valves (106) formed by magnetic fields generated by whispering gallery mode radiation (101) and secondary radiations generated by whispering gallery mode radiation (102),
magnetic nozzle (107) formed by magnetic fields generated by whispering gallery mode radiation (101) and secondary radiations generated by whispering gallery mode radiation (102).

2. Whispering gallery mode fusion power plant and rocket propulsion (100) characterized by comprising:
magnetic fields generated by whispering gallery mode radiation (101),
secondary radiations generated by whispering gallery mode radiation (102),
compressed fusion fuel (103) generated by magnetic fields generated by whispering gallery mode radiation (101) and secondary radiations generated by whispering gallery mode radiation (102),
wakefield fast ignition radiation (104) focused by magnetic fields generated by whispering gallery mode radiation (101) and secondary radiations generated by whispering gallery mode radiation (102),
liquid metal droplets filled with fusion fuel (108) generated by magnetic fields generated by whispering gallery mode radiation (101) and secondary radiations generated by whispering gallery mode radiation (102),
magnetic valves (106) formed by magnetic fields generated by whispering gallery mode radiation (101) and secondary radiations generated by whispering gallery mode radiation (102),
magnetic nozzle (107) formed by magnetic fields generated by whispering gallery mode radiation (101) and secondary radiations generated by whispering gallery mode radiation (102).

3. Wakefield fast ignition radiation (104) according to claims 1 and 2, characterized in that it can be particle radiation or electromagnetic radiation, or both.
